(19) United States
(12) Patent Application Publication
(10) Pub. No.: US 2020/0398628 A1
(43) Pub. Date: Dec. 24, 2020

(54) POWERED WEIGHT DISTRIBUTION SYSTEM FOR A VEHICLE

(71) Applicant: Nidec Motor Corporation, St. Louis, MO (US)

(72) Inventors: Thomas Schardt, Edwardsville, IL (US); Oran Henry Wiseman, Maryville, IL (US)

(73) Assignee: Nidec Motor Corporation, St. Louis, MO (US)

(21) Appl. No.: 16/903,923

(22) Filed: Jun. 17, 2020

Related U.S. Application Data
(60) Provisional application No. 62/864,332, filed on Jun. 20, 2019.

(51) Int. Cl. B60G 17/019; B60L 7/10

(52) U.S. Cl. CPC B60G 17/019; B60G 2401/00; B60G 2400/61; B60L 7/10

(57) ABSTRACT

A powered weight distribution system is provided for a vehicle having a platform on which a load is supported. The powered weight distribution system includes a shiftable axle assembly. The shiftable axle assembly includes a drivable axle and a frame supporting the drivable axle. The frame is configured to be supported on the platform. The frame is switchable between a locked configuration in which the frame is fixed relative to the platform and an unlocked configuration in which the frame is shiftable relative to the platform. The shiftable axle assembly further includes a powering element configured to rotatably drive the drivable axle, such that the frame and the drivable axle shift relative to the platform when the frame is in the unlocked configuration and the drivable axle is rotated by the powering element.

### CROSS-REFERENCE TO RELATED APPLICATION

1. Priority Application

The present application claims the benefit of and priority from U.S. Provisional Patent Application No. 62/864,332, filed Jun. 20, 2019, the entire disclosure of which is hereby incorporated by reference herein.

### BACKGROUND OF THE INVENTION

### 1. Field of the Invention

The present invention relates generally to a vehicle having a repositionable axle assembly.

### 2. Discussion of the Prior Art

Those of ordinary skill in the art will appreciate that vehicles often include multiple axle assemblies cooperatively supporting cargo or goods having a weight. In some vehicles, one of the axle assemblies is a repositionable axle assembly that can be shifted relative to the rest of the vehicle. As will be discussed in greater detail below, shifting of the axle assembly changes the distribution of the weight amongst the axle assemblies.

### SUMMARY

According to one aspect of the present invention, a powered weight distribution system is provided for a vehicle having a platform on which a load is supported. The powered weight distribution system includes a shiftable axle assembly. The shiftable axle assembly includes a drivable axle and a frame supporting the drivable axle. The frame is configured to be supported on the platform. The frame is switchable between a locked configuration in which the frame is fixed relative to the platform and an unlocked configuration in which the frame is shiftable relative to the platform. The shiftable axle assembly further includes a powering element configured to rotatably drive the drivable axle, such that the frame and the drivable axle shift relative to the platform when the frame is in the unlocked configuration and the drivable axle is rotated by the powering element.

Among other things, provision of a powered weight distribution system enables powered redistribution of a weight carried by the platform amongst the axle assemblies of the vehicle.

This summary is provided to introduce a selection of concepts in a simplified form. These concepts are further described below in the detailed description of the preferred embodiments. This summary is not intended to identify key features or essential features of the claimed subject matter, nor is it intended to be used to limit the scope of the claimed subject matter.

Various other aspects and advantages of the present invention will be apparent from the following detailed description of the preferred embodiments and the accompanying drawing figures.

### BRIEF DESCRIPTION OF THE DRAWING FIGURES

Preferred embodiments of the present invention are described in detail below with reference to the attached drawing figures, wherein:

FIG. 1 is a side perspective view of a vehicle in accordance with a first embodiment of the present invention, wherein the vehicle broadly includes a tractor, a trailer carrying a cargo, and a plurality of weight-bearing axle assemblies including steer, drive, and rear axle assemblies;

FIG. 2 is a side perspective view of the vehicle of FIG. 1, but with the rear axle assembly shifted to an alternate position to redistribute the weight amongst the axle assemblies;

FIG. 3 is an enlarged, fragmented bottom rear perspective view of a portion of the vehicle of FIGS. 1 and 2, particularly illustrating the rear axle assembly in the position of FIG. 1;

FIG. 4 is a bottom front perspective view of the vehicle portion of FIG. 3;

FIG. 5 is a schematic system illustration of the vehicle of FIGS. 1-4;

FIG. 6 is a schematic system illustration of a vehicle in accordance with a second embodiment of the present invention;

FIG. 7 is a schematic system illustration of a vehicle in accordance with a third embodiment of the present invention;

FIG. 8a is a schematic illustration of a user interface of a control system for the rear axle assembly of FIGS. 1-4, particularly illustrating the vehicle having an overloaded drive axle assembly, the rear axle assembly disposed in a substantially rearward position, and the rear axle assembly frame in an unlocked configuration to enable shifting thereof; and

FIG. 8b is a schematic illustration of the user interface of FIG. 8a after shifting of the rear axle assembly into a more forward position has resulted in redistribution of the weight, including a decrease of the drive axle weight to an acceptable level, with the rear axle assembly frame in the locked configuration.

The drawing figures do not limit the present invention to the specific embodiments disclosed and described herein. While the drawings do not necessarily provide exact dimensions or tolerances for the illustrated structures or components, the drawings are to scale with respect to the relationships between the components of the structures illustrated in the drawings.

### DETAILED DESCRIPTION

The present invention is susceptible of embodiment in many different forms. While the drawings illustrate, and the specification describes, certain preferred embodiments of the invention, it is to be understood that such disclosure is by way of example only. There is no intent to limit the principles of the present invention to the particular disclosed embodiments.

Furthermore, unless specified or made clear, the directional references made herein with regard to the present invention and/or associated components (e.g., top, bottom, upper, lower, inner, outer, etc.) are used solely for the sake of convenience and should be understood only in relation to each other. For instance, a component might in practice be oriented such that faces referred to as “top” and “bottom” are sideways, angled, inverted, etc. relative to the chosen frame of reference.

### Vehicle Overview

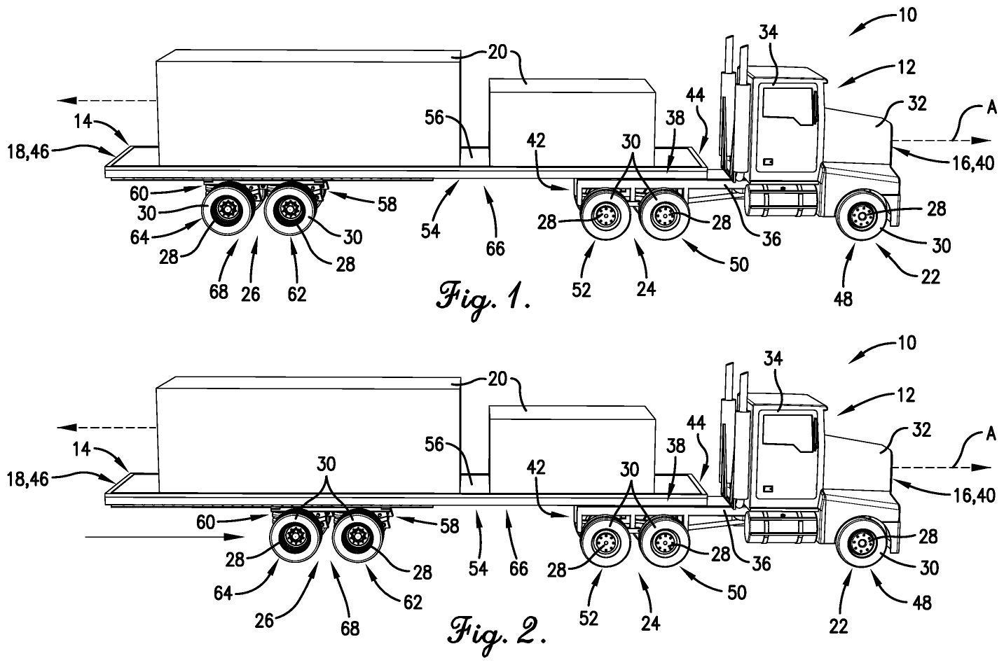

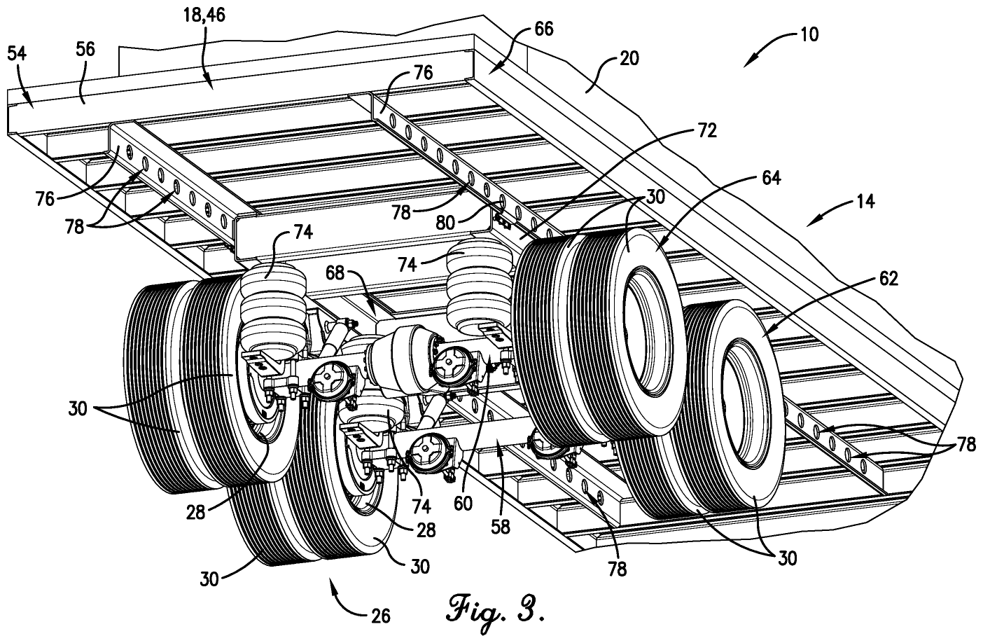

Turning now to FIGS. 1 and 2, a vehicle 10 is illustrated. The vehicle 10 in a preferred embodiment, as illustrated, is a tractor-trailer as might be used in the trucking industry. That is, in a preferred embodiment, the vehicle 10 preferably includes a tractor 12 and a trailer 14. However, a variety of vehicle types fall within the scope of some aspects of the present invention. For instance, the vehicle 10 might be alternatively be a bus, tanker, box truck, etc.

In a preferred embodiment, the trailer 14 is attached to the tractor 12 via any means known in the art. Such attachment means couple the trailer 14 to the tractor 12 such that motion of the tractor 12 at least substantially results in complementary motion of the trailer 14. The attachement means may facilitate pivoting of the trailer 14 relative to the tractor 12, as in a preferred embodiment. Alternatively, the coupling may be rigid and/or facilitate other forms of relative motion between the tractor and trailer.

The vehicle 10 preferably defines fore and aft vehicle margins 16 and 18. A longitudinal axis A of the vehicle 10 is defined between the vehicle margins 16 and 18. The vehicle 10 is configured to primarily move in a fore-aft direction defined along the longitudinal axis A, which is alternatively referred to herein as the fore-and-aft axis A.

As will be understood by those of ordinary skill in the art, parts of the vehicle 10 will deviate from the axis A and/or the fore-aft direction of travel during the course of conventional operations such as turns, as well as other in other less common circumstances such as skids. However, development of a general directional frame of reference herein is necessary to more clearly describe the inventive features of the vehicle 10.

The vehicle 10 preferably supports or is configured to support cargo 20. As shown in FIGS. 1 and 2, for instance, cargo 20 is supported on the trailer 14.

In a preferred embodiment, as illustrated, the vehicle 10 includes three axle assemblies: a steer axle assembly 22, a drive axle assembly 24, and a rear axle assembly 26. The axle assemblies 22, 24, and 26 cooperatively support the vehicle 10 and the cargo 20.

Wheels 28 and tires 30 are preferably mounted to respective ones of the axle assemblies 22, 24, and 26, such that rotation of relevant components of the axle assemblies 22, 24, and 26 results in rotation of the wheels 28 and tires 30. Rotation of the tires 30, combined with engagement of the tires 30 against an underlying surface (e.g., a road, the ground, etc.) results in rolling motion of the vehicle 10 as a whole. The axle assemblies 22, 24, and 26 will be discussed in greater detail below.

It is noted that at least some aspects of the present invention apply to vehicles having more or fewer axle assemblies than illustrated in FIGS. 1 and 2. Still further, it is noted that a variety of axle types and configurations are permissible without departing from the scope of the present invention, except as specified below. For instance, certain of the axle assemblies might include lift axles or other features known to those of ordinary skill in the art. It is also permissible for the axles to support structures in addition to or other than wheels and tires, including but not limited to tracks or rollers.

### Tractor

The tractor 12 of the illustrated embodiment preferably includes, among other things, a hood 32, a cab 34, and a frame 36.

A traction motor (not shown) such as an internal combustion engine, a diesel engine, or an electric motor is preferably disposed beneath the hood 32 and provides a primary propulsive force for the vehicle 10, as is conventional. Other power elements might alternatively or additionally be provided. For purposes of clarity, this traction motor will be referred to hereafter as the “primary” traction motor due to its key role in overall vehicle propulsion.

The cab 34 is preferably configured to house a vehicle operator, although it is permissible according to some aspects of the present invention for the vehicle to be designed for autonomous driving and thus not configured with operator comfort in mind.

The frame 36 preferably includes a coupling element (not shown) for interconnecting the tractor 12 and the trailer 14. An overlapping region 38 in which portions of the tractor 12 and the trailer 14 overlap or overlie each other is preferably defined, as shown in FIGS. 1 and 2. More particularly, the tractor 12 preferably includes fore and aft tractor margins 40 and 42. The trailer 14 preferably includes fore and aft trailer margins 44 and 46. The aft tractor margin 42 is preferably disposed aftward of the fore trailer margin 44, such that the overlapping region 38 is formed.

The tractor 12 also preferably includes both the steer axle assembly 22 and the drive axle assembly 24. In the illustrated embodiment, the steer axle assembly 22 is disposed generally below the aforementioned primary traction motor (not shown) so as to primarily support the weight of the primary traction motor. The steer axle assembly 22 also preferably provides steering of the vehicle 10. That is, the steer axle assembly 22 is preferably connected to a steering assembly (not shown).

In the illustrated embodiment, the steer axle assembly 22 includes a single, laterally extending axle (not shown) associated with a single set 48 of wheels 28 and tires 30. (Laterally extending as used herein will be understood by those of ordinary skill in the art to mean horizontally, or parallel to an underlying surface such as a road or the ground, and orthogonal to the fore-aft axis A, except for variations caused by steering and suspension systems (not shown).) However, alternate configurations fall within the scope of the present invention.

The drive axle assembly 24 is preferably mounted to the tractor frame 36 so as to be disposed below and provide support to the overlapping region 38. That is, the drive axle assembly 24 preferably in part supports both the tractor 12 and the trailer 14. Most preferably, the drive axle assembly 24 is disposed adjacent or somewhat near the fore trailer margin 44 and the aft tractor margin 40.

The drive axle assembly 24 is preferably driven by the primary traction motor in any appropriate manner known in the art. As will be readily understood by those of ordinary skill in the art, driven rotation of the wheels 28 associated with the drive axle assembly 24 will result in driven propulsion of the tractor 12 and, in turn, complementary motion of the trailer 14.

The drive axle assembly 24 preferably includes a pair of laterally extending axles (not shown) disposed parallel to one another and aligned in the fore-and-aft direction. The axles preferably support respective sets 50 and 52 of wheels 28 and tires 30. However, alternate configurations fall within the scope of the present invention.

### Trailer

The trailer 14 preferably includes a body 54 defining the fore and aft trailer margins 44 and 46, with the body 54 generally extending along the previously defined fore-and-aft axis A.

The body 54 preferably supports and, in some embodiments, contains the cargo 20. The body 54 in the illustrated embodiment, for instance, comprises a flat platform or bed 56 but is devoid of sides or a top, such that the trailer 14 may be described as a flatbed trailer. Enclosed trailers (having, for instance, rectangularly prismatic bodies) and other forms of trailer fall within the scope of the present invention, however.

The trailer 14 preferably includes the aforementioned rear axle assembly 26. The rear axle assembly 26 is preferably disposed aftward of the drive axle assembly 24, with the drive axle assembly 24 thereby being disposed longitudinally between the steer axle assembly 22 and the rear axle assembly 26.

As will be discussed in greater detail below, the rear axle assembly 26 preferably includes parallel, laterally extending fore and aft axles 58 and 60, aligned with one another and spaced closely together in the fore-and-aft direction. The fore axle 58 supports a set 62 of wheels 28 and tires 30, and the aft axle 60 supports a set 64 of wheels 28 and tires 30. Those of ordinary skill in the art will recognize that the rear axle assembly 26 might thus alternately be referred to as a tandem axle assembly 26.

### Axle Loads

In a preferred embodiment, the cargo 20 generates a weight-based (alternatively, gravity-based) downward force or load on the platform 56 that is cooperatively supported primarily by the drive axle assembly 24 and the rear axle assembly 26. This downward force will be referred to herein as the cargo weight. A portion of the cargo weight may in some instances also be supported by the steer axle assembly, although vehicle geometry conventionally dictates that such portion will be relatively small.

Furthermore, an inherent or vehicle weight associated with the weights of non-axle vehicle components 66 (i.e., the components of the vehicle 10 excluding the axle assemblies 22, 24, and 26), as well as with any operators and/or passengers, is cooperatively supported by the steer axle assembly 22, the drive axle assembly 24, and the rear axle assembly 26. Thus, the cargo weight and the vehicle weight each contribute to a total or combined/cumulative weight that varies along the fore-aft axis A of the vehicle 10 and is distributed between (i.e., supported by) the steer axle assembly 22, the drive axle assembly 24, and the rear axle assembly 26 in typically unequal portions.

The respective portions of the combined weight carried by each of the axle assemblies 22, 24, and 26 are dictated by the largely invariable positions of the non-axle components 66 of the vehicle 10, the sometimes variable (although often only with significant inconvenience) positions of the cargo 20, and the positions of the axle assemblies 22, 24, and 26. These weight portions will be referred to herein as the steer axle weight, the drive axle weight, and the rear axle weight.

In a preferred embodiment, as indicated by FIGS. 1 and 2, the rear axle assembly 26 of the present invention is shiftable in the fore-aft direction or, alternatively stated, along the fore-aft axis A. Stated still another way, the rear axle assembly 26 is shiftable relative to the drive axle assembly 24, which is in a fixed position.

Repositionability of the rear axle assembly 26 enables an operator or operating/controlling system to adjust the weight portions carried by each of the axle assemblies 22, 24, and 26. That is, by shifting the rear axle assembly 26 forward or backward along fore-aft axis A, an operator or operating/controlling system can adjust the magnitudes of the drive axle weight and the rear axle weight, and in some instances (as dictated by vehicle design and/or cargo distribution) the steer axle weight. It is particularly noted that, even if the magnitude of the steer axle weight does not change, the individual proportionality of the steer, drive, and rear axle weights relative to one another changes upon shifting of the rear axle assembly 26. Such adjustments in the axle weights and/or their proportionality relative to one another are achieved without any changes to the cargo weight, the vehicle weight, or the total weight, and additionally without any shifting of the cargo 20 itself.

With reference to FIGS. 1 and 2, for instance, the rear axle assembly 26 bears less of the total weight in FIG. 1, in which the rear axle assembly 26 is disposed in a more aftward position, than it does in FIG. 2, in which it is disposed in a more forward position. Conversely, the drive axle assembly 24 bears more of the total weight in FIG. 1 than it does in FIG. 2. That is, the rear axle weight is lower in FIG. 1 than in FIG. 2, and the drive axle weight is higher in FIG. 1 than in FIG. 2.

As will be well known to those of ordinary skill in the art, jurisdictions often impose limits on various cumulative/total weights associated with a given vehicle, as well as weights associated with individual axle assemblies. The shiftability or repositionability of the rear axle assembly 26 of the present invention enables the steer, drive, and rear axle weights to be redistributed or rebalanced in an effort to efficiently achieve acceptable loading in accordance with relevant regulations.

As used herein, “jurisdictions” may refer to or be related to civil governing authorities, corporate entities, and/or other regulatory bodies or individuals. It is also noted that the weights referred to herein may or may not correspond exactly to the weights restricted by one or more jurisdictions. For instance, whereas the weights referred to herein thus far are those supported by the various axle assemblies, either individually or collectively, regulations issued by relevant jurisdictions may be based on total weights supported by an underlying surface (e.g., a road) at each of the axle assembly locations. Such weights would include both relevant ones of the weights referred to herein and the weights of relevant ones of the axle assemblies themselves. Despite any discrepancies in load/weight definitions or terminology, however, those or ordinary skill in the art will recognize that the principles of the present invention are nevertheless broadly applicable.

### Conventional Weight Rebalancing

In a conventional commercial loading process for a tractor-trailer or other vehicle similar to the vehicle 10 except with regard to the inventive features described herein, an operator (e.g., a truck driver) backs the tractor-trailer to a loading dock. The trailer is loaded with cargo from the loading dock. The operator then drives to a scale or weigh station for weighing to determine weights relevant to the current jurisdiction. For instance, the operator might acquire both a total or gross vehicle weight and specific axle weights. If the total weight is over an allowed maximum, the weight must be decreased, e.g., by unloading of a portion of the cargo. If the total weight is permissible but one of more of the axle weights is unacceptable, the cargo can in some instances be redistributed to achieve acceptable weight distribution. Such redistribution is generally difficult, however. Thus, if the rear or tandem axle is repositionable (as in the vehicle 10 of the present invention), the driver typically instead shifts the rear axle assembly forward or backward to attempt to meet the axle weight requirements without cargo redistribution. (In some instances, cargo redistribution may be necessary despite repositioning of the rear axle assembly).

Conventionally, shifting of the rear axle assembly is a tedious process. A stop bar is placed at the estimated correct axle position (i.e., a position that the operator believes based on an educated guess will rectify the weighting issue or issues). The stop bar position will conventionally correspond to a pin stop, with each pin stop typically corresponding to a predetermined weight shift. For instance, each pin stop might correspond to two hundred fifty (250) lb of shifting or five hundred (500) lb of shifting.

After placement of the stop bar, the operator typically manually releases trailer suspension pins that lock the rear axle assembly into place during normal operation (such as on-road driving). Release of these pins by the operator allows the rear axle assembly and the rest of the trailer (i.e., the trailer body) to slidably shift in the fore or aft direction relative to one other, with the rear axle assembly typically being guided via rails mounted to the trailer body. Shifting is typically achieved via locking of the trailer brakes, such that the rear axle assembly remains stationary, and subsequent forward or reverse driving of the tractor (and consequent forward progress or backing up of the attached trailer body) such that the trailer body slides forward or backward over the stationary rear axle assembly.

Shifting is complete when the stop bar is contacted by the rear axle assembly. The operator then verifies that the trailer suspension pins have been reengaged (e.g., extend securely through corresponding pin stops) and repositions the stop bar before restarting the weighing process.

In some instances, release of the trailer suspension pins may instead be achieved via a powered system such as a pneumatic system. It is also known to provide onboard scales to present continuous or on-demand readings of relevant weights, potentially eliminating unsuccessful visits to scales or weigh stations.

### Powered Weight Distribution System

As noted previously, the rear axle assembly 26 of the present invention is shiftable in the fore-aft direction. Furthermore, such shifting of the rear axle assembly 26 is powered.

More particularly, the vehicle 10 in a broad sense includes a powered weight distribution system 68. The weight distribution system 68 includes the rear axle assembly 26 and a control system 70 configured to at least in part control shifting of the rear axle assembly 26. Several vehicle configurations utilizing the powered weight distribution system 68 are described in detail below.

### Single Motor Driving a Single Axle

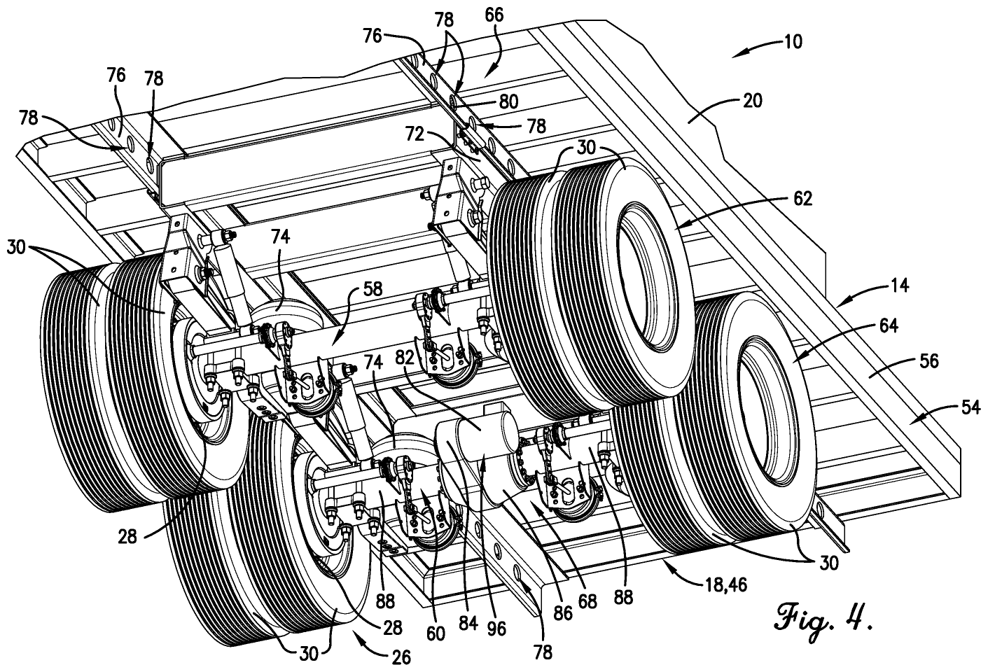

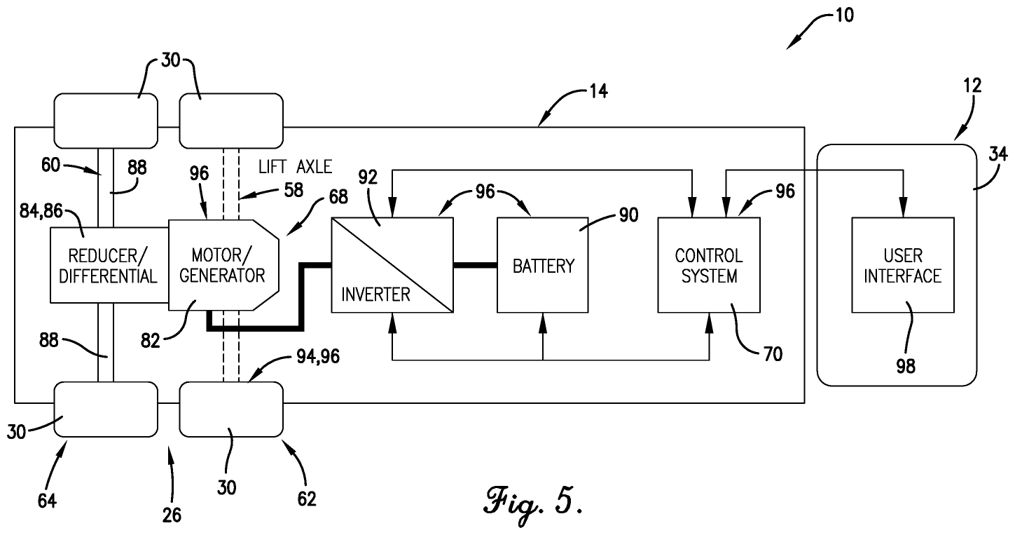

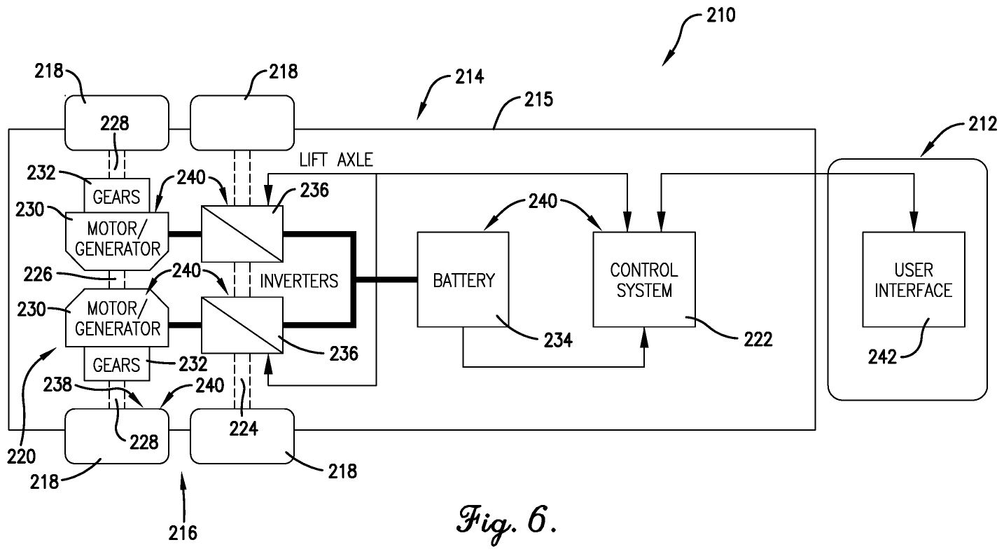

A first preferred embodiment of the present invention is illustrated in detail in FIGS. 3 and 4 and shown schematically in FIG. 5. As best shown in FIGS. 3 and 4, the rear axle assembly 26 includes a frame 72 and the aforementioned pair of laterally extending, parallel fore and aft axles 58 and 60 connected relative to the frame 72.

As noted previously, wheel and tire sets 62 and 64 are mounted to the fore and aft axles 58 and 60, respectively.

In the illustrated embodiment, airbags 74 are also provided. The airbags 74 are preferably disposed below the frame 72 and provide shock absorption and weight support. It is permissible according to some aspects of the present invention, however, for airbags to be omitted.

The frame 72 is slidably mounted to rails 76 fixed to the trailer 14 and, most preferably, the platform 56 thereof. A plurality pin stops 78 are formed in the rails 76. In the illustrated configuration, a plurality of pins 80 extend from the frame 72 and through corresponding ones of the pin stops 78 so as to selectively prevent relative motion between the rear axle assembly 26 and the trailer 14. In keeping with descriptions above regarding conventional rear axle assembly repositioning, however, such pins 80 are shiftable out of the pin stops 78 to enable relative shifting to occur. That is, the frame 72 is switchable between a locked configuration in which the frame 72 is fixed relative to the rails 76 and, more broadly, the platform 56 (and the remainder of the vehicle 10), and an unlocked configuration in which the frame 72 is shiftable relative to the rails 76 and, more broadly, the platform 56 (and the remainder of the vehicle 10).

It is noted that locking and/or unlocking of the frame 72 via shifting of the pins 80 may be via manual, electrically actuated, pneumatically actuated, or otherwise-facilitated shifting or manipulation of the pins 80.

In the illustrated embodiment, the fore axle 58 is non-drivable (i.e., rolling) axle. The fore axle 58 may be a lift axle, although a fixed configuration is also permissible.

The aft axle 60 is a drivable axle. More particularly, a powering element 82 is provided to selectively rotatably drive the aft or drivable axle 60. Most preferably, the powering element 82 is an electric motor 82, although other power sources, including but not limited to non-electric motor or engines, are permissible according to some aspects of the present invention. Powered or driven rotation of the aft axle 60 by the powering element or electric motor 82 shifts the frame 72 and the aft axle 60 (or, more broadly, the rear axle assembly 26) relative to the platform 56 and the remainder of the vehicle 10 when the frame 72 is in the unlocked configuration.

In greater detail still, the electric motor 82 in the illustrated embodiment is preferably a high speed motor flanged directly onto (i.e., mounted directly to) a reducer 84 and a differential 86. The reducer 84 and the differential 86 are preferably mounted to the aft or drivable axle 60. (Although the motor 82 is shown schematically in FIG. 5 as proximate to the fore axle 58, FIG. 5 is not intended to indicate mounting of the motor 82 onto the fore axle 58.)

The drivable axle 60 includes a pair of substantially aligned (i.e., along a shared lateral axis), rotatably drivable axle shafts (or “half shafts”) 88 extending laterally from the differential 86. That is, a single motor 82 drives both sides of the single drivable axle 60 or, alternatively stated, the pair of axle shafts 88 of a single axle 60.

It is noted that other configurations in which a single motor drives a single axle are also permissible according to some aspects of the present invention. For instance, a low speed motor might be connected to a reducer and a differential by means of a drive shaft.

In a preferred embodiment, as illustrated, the electric motor 82 receives power from an energy storage system 90. The energy storage system 90 is preferably a battery 90, although other systems or devices, including but not limited to supercapacitors and multi-battery arrays, might alternatively or additionally be used.

An inverter 92 is also preferably provided to convert direct current as output by the battery 90 into alternating current as required by the electric motor 82. Although a discrete inverter 92 is shown, it is noted that integrated motor/inverter configurations fall within the scope of the present invention. Power sources that do not require inverters are also permissible according to some aspects of the present invention.

In a preferred embodiment of the present invention, the battery 90 and, in turn, the motor 82, receive power from a renewable energy source. In the illustrated embodiment, for instance, the renewable energy source comprises a regenerative braking system 96 that includes the electric motor 82, which additionally functions as a generator and will thus hereafter be referred to as the motor/generator 82. As will be discussed in greater detail below, additional or alternative power sources for the battery may also be provided.

The regenerative braking system 96 will not be described in detail herein. However, in a broad sense, braking of the trailer 14 and, more specifically, the aft axle 60 results in generation of power by the motor/generator 82. Such power is transferred to and stored by the battery 90 and is returned to the motor/generator 82 when required to rotatably drive the aft axle 60 to reposition the rear axle assembly 26. The regenerative braking system 96 may thus be understood to include, among other things, brake components themselves, the motor/generator 82, the inverter 92, the battery 90, and the control system 70.

Although a regenerative braking system 96 is most preferably provided, it is noted that additional or alternative sources of energy might be utilized. Among other things, for instance, further or alternative systems might be provided to capture and convert solar, thermal, wind, and/or kinetic energy.

In a preferred embodiment, the control system 70 at least in part controls shifting of the frame 72 by controlling the motor/generator 82.

The control system 70 also preferably includes a plurality of load or weight sensors (not shown) for sensing the steer, drive, and rear axle weights. Such sensors might be integrated with the air bags, provided in the form of load cells mounted on solid suspension, or presented in another manner known in the art.

Still further, the control system 70 preferably includes a processor configured to use the sensed steer, drive, and rear axle weights to determine an acceptable position or range of positions for the rear axle assembly 26 to comply with applicable regulations (if any acceptable positions exist, given the existing cargo 20). It is noted that the processor may be configured to account for the inherent weights of the axle assemblies themselves, and perhaps other factors, in addition to accounting for the sensed axle weights that are supported by the axle assemblies. Such accounting may be necessary to correspond to the particular requirements of a relevant jurisdiction.

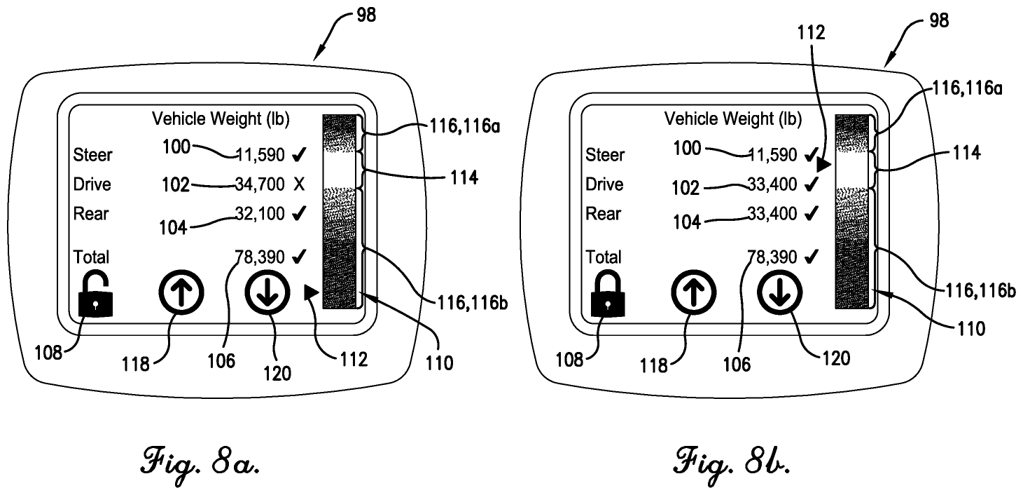

As shown in detail in FIGS. 8a and 8b, the control system 70 preferably includes a user interface 98 facilitating powered adjustment of the rear axle assembly 26 into a suitable position. With reference to FIG. 8a, for instance, the user interface 98 displays the current steer, drive, and rear axle weights 100, 102, and 104 and indicates by an “X” or checkmark which of the axle weights 100, 102, and 104 are unacceptable or acceptable in view of designated restrictions. A total or gross vehicle weight 106 is also provided and likewise designated acceptable or unacceptable. More particularly, in the illustrated example, the drive axle weight 102 is over the example drive and rear axle weight limits of thirty four thousand (34,000) lb. (It is again noted that such axle weight limits may vary by jurisdiction.) This deficiency is indicated by an “X” next to the current weight 102. The steer axle weight 100 and the rear axle weight 104 are acceptable, however, as is the total vehicle weight 106, and are designated so by respective checkmarks. (It is noted that color coding or other means may alternatively or additionally be used to indicate acceptable and unacceptable weighting/loading.)

A lock icon 108 is also provided to indicate the status of the lock pins 80 or, more broadly, the locked or unlocked configuration of the frame 72. In a preferred embodiment, the control system 70 electronically controls switching of the frame 72 between the locked and unlocked configurations upon, for instance, pressing of the lock icon 108 by the vehicle operator. Aa noted above, however, alternative automated methods (e.g., using pneumatic actuation, etc.) or manual methods of such switching are permissible.

The user interface 98 also preferably includes a schematic guide illustration 110 of at least a portion the trailer body 54, including a positionally relevant representation 112 of the rear axle assembly 26. That is, the position of the representation 112 relative to the guide illustration 110 preferably corresponds to the actual position of the rear axle assembly 26 relative to the trailer body 54.

As will be readily understood by those of ordinary skill in the art, if the guide illustration 110 does not represent the entire trailer body 54, the portion of the trailer body 54 included in the guide illustration 110 should include at least the entire fore-aft range of motion of the rear axle assembly 26 or, alternatively stated, the extent of the rails 76. This approach is illustrated in FIGS. 8a and 8b. It is noted that more extensive guide illustrations, including those that include the entire vehicle 10, are also permissible without departing from the scope of the present invention.

Varying levels of detail (e.g., realistic vs. schematic illustrations, etc.) are also permissible. For instance, the representation 112 of the rear axle assembly 26 in FIGS. 8a and 8b is an arrow, although other representations (e.g., of tires) are also permissible.

In a preferred embodiment, the guide illustration 110 is provided with shading or color-coding to indicate a calculated acceptable position or range of positions 114 for the rear axle assembly 26. Likewise, any unacceptable position or positions 116 are also indicated. In the illustrated example, a small range of acceptable positions 114 is disposed rearward of a first range 116a of unacceptable positions and forward of a large range 116b of unacceptable positions. As indicated above, however, certain loading scenarios (e.g., a very light cargo load) might be such that all positions are acceptable, while other loading scenarios (e.g., an overly heavy or very unevenly distributed cargo load) might be such that no positions are acceptable.

Preferably, forward and rearward arrows 118 and 120, respectively, corresponding to respective forward or rearward motion of the rear axle assembly 26 relative to the trailer body 54, are provided. Pressing of either of the arrows 118 and 120 by an operator when the frame 72 is unlocked results in corresponding driven rotation of the aft axle 60, as powered by the motor/generator 82 via the battery 90. As discussed in detail above, such rotation results in shifting of the rear axle assembly 26, the extent and resulting position of which is preferably indicated in real time by the representation 112. Real-time updating of the axle weights 100, 102, and 104 is also preferably provided, with acceptable real-world weighting/loading achieved when, as shown in FIG. 8b, the representation 112 aligns with the acceptable position or range of positions 114 on the guide illustration 110 and, in turn, the axle weights 100, 102, and 104, as well as the total weight 106, are all indicated as acceptable by means of check marks.

It is also permissible according to some aspects of the present invention for the user interface to additionally or alternatively be provided with means for a user to initiate automated positioning of the rear axle assembly. In such an instance, an algorithm might be used to determine an optimal position of the rear axle assembly, with movement of the rear axle assembly into the determined optimal position occurring automatically after selection by a user of an “auto-position” icon or similar. That is, pressing of arrows or the like to control the motion of the rear axle assembly would be unnecessary.

It is further noted that locking and/or unlocking of the frame might occur automatically upon pressing of one more of the arrows, an auto-position icon, etc., eliminating the need for additional steps (e.g., as described above with regard to the lock icon 108) associated with movement of the pins.

Of course, a variety of additional or alternative features might be incorporated into the user interface as well without departing from the scope of some aspects of the present invention. Among other things, for instance, clock, calendar, weather, mapping, communications, vehicle monitoring (e.g., fuel level, tire pressure, cargo environmental temperature, battery level, etc.), and vehicle control features might also be provided.

The user interface 98 may be embodied in a variety of ways without departing from the scope of some aspects of the present invention. For instance, the user interface 98 may be associated with an installable or pre-installed application or program for a mobile phone, tablet, laptop, or desktop computer; a separately installable or pre-installed/integrated monitor in the cab 34; a trailer-mounted interface; a remote control; and/or a combination of one or more of the above.

In addition to the various components described above, it will be readily understood by those of ordinary skill in the art that a variety of additional components may also be provided without departing from the scope of some aspects of the present invention. Some such components may be necessary for efficient and effective operation of the components specifically described herein, may be entirely unrelated, may be related but non-essential, and so on. For instance, a cooling pack is preferably provided for the motor/generator 82, and an electrical distribution and control box might be provided.

It is also noted that the mounting locations of various components may also vary in keeping with the particular requirements of the vehicle and/or axle assembly. For instance, while the battery in the illustrated embodiment is mounted to the trailer body 54 (such mounting not being shown), it is permissible for the battery to instead be mounted to the frame or another component of the rear axle assembly.

### Dual Motors Driving a Single Axle in a Dual Axle Configuration

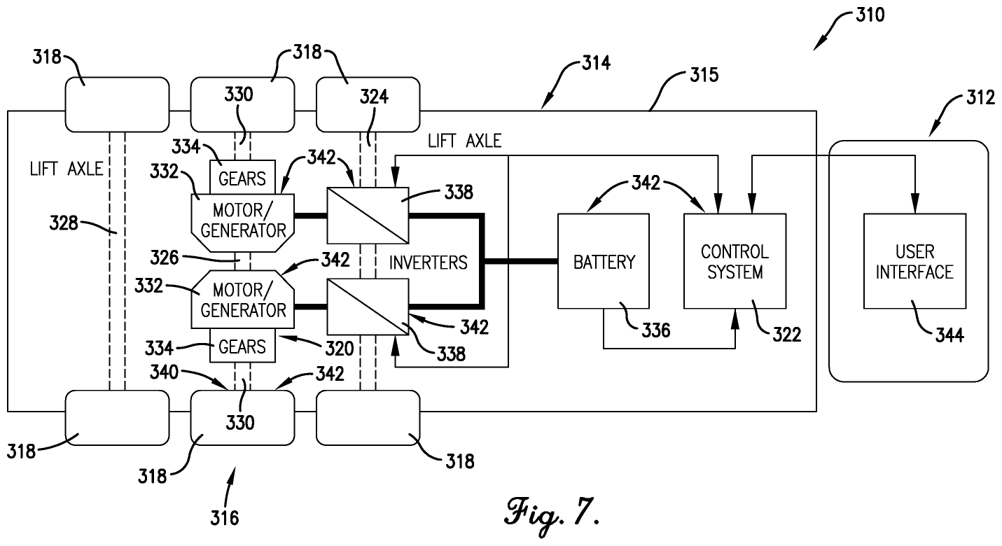

A second preferred vehicle is illustrated schematically in in FIG. 6. It is initially noted that, with certain exceptions to be discussed in detail below, many of the elements of the vehicle 210 of the second embodiment are the same as or very similar to those described in detail above in relation to the vehicle 10 of the first embodiment. Therefore, for the sake of brevity and clarity, redundant descriptions and numbering will be generally avoided here. Unless otherwise specified, the detailed descriptions of the elements presented above with respect to the first embodiment should therefore be understood to apply at least generally to the second embodiment, as well.

Similarly to the vehicle 10, the vehicle 210 of the second preferred embodiment preferably includes a tractor 212 and a trailer 214. The trailer 214 includes a platform 215 configured to support cargo having a cargo weight. The vehicle 210 includes multiple axle assemblies, including a rear axle assembly 216. Wheels (not shown) and tires 218 are preferably mounted to respective ones of the axle assemblies, including the rear axle assembly 116.

Similarly to the rear axle assembly 26 of the first embodiment, the rear axle assembly 216 of the second embodiment is shiftable in a fore-aft direction. Such shifting of the rear axle assembly 216 is powered.

More particularly, the vehicle 210 in a broad sense preferably includes a powered weight distribution system 220 including the rear axle assembly 216 and a control system 222 configured to at least in part control shifting of the rear axle assembly 216.

As shown schematically in FIG. 6, the rear axle assembly 216 includes pair of laterally extending, parallel fore and aft axles 224 and 226 connected relative to a frame (not shown). As described above with respect to a first embodiment of the present invention, the frame is preferably slidably mounted relative to the platform 215.

In the illustrated embodiment, the fore axle 224 is non-drivable (i.e., rolling) axle. In contrast, the aft axle 226 is a drivable axle 226. The drivable axle 226 preferably includes a pair of substantially aligned (i.e., along a shared lateral axis), rotatably drivable axle shafts (or “half shafts”) 228.

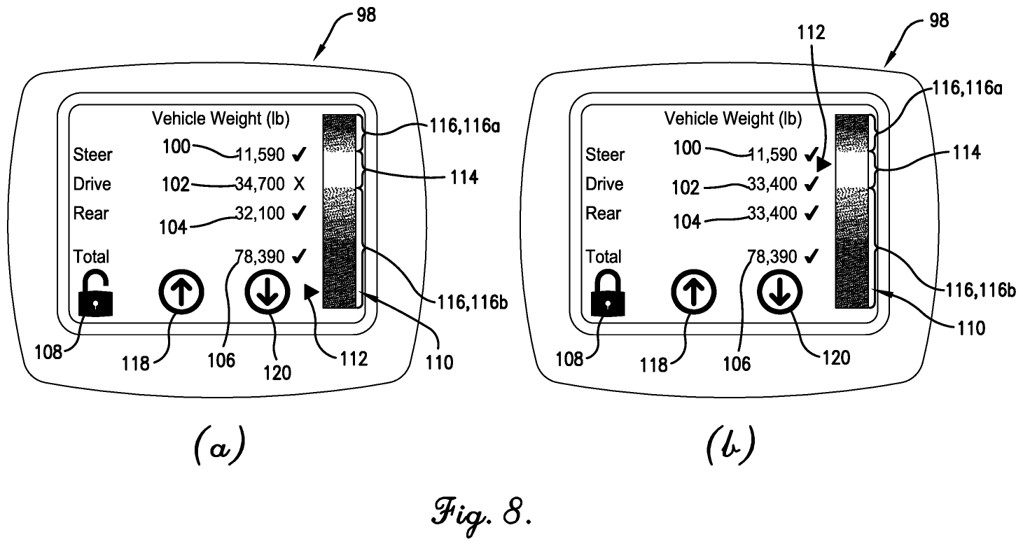

A respective powering element 230 is provided to selectively rotatably drive each of the axle shafts 228. That is, a first powering element 230 drives a first one of the axle shafts 228, while a second powering element 230 drives a second one of the axle shafts 228. As indicated schematically in FIG. 7, the axle shafts 228 may in some configurations be part of or embedded in the respective powering element 230. Powered or driven rotation of the aft axle 226 by the powering elements 230 shifts the frame (not shown) and the aft axle 226 (or, more broadly, the rear axle assembly 216) relative to the platform 215 and, more broadly, the remainder of the vehicle 210 when the frame 72 is in an unlocked configuration, largely as described above with respect to the first embodiment.

Most preferably, each powering element 230 is an electric motor 230. In greater detail still, the electric motors 230 in the illustrated embodiment are each preferably high speed motors driving only the wheel or wheels (not shown) mounted to a given half shaft 228 of the rear axle assembly 216. The electric motors 230 may be sleeved into the existing drivable axle 226 or mounted directly onto the wheel hub (not shown).

It is preferred that gears 232 are provided for each motor 230 (e.g., to reduce the rotational speed between the respective motor 230 and any wheel or wheels and, in turn, tire or tires 218 associated with the given axle shaft 228).

In a preferred embodiment, as illustrated, the electric motors 230 receive power from a shared energy storage system 234. The energy storage system 234 is preferably a battery 234.

An independent inverter 236 is preferably provided for each motor 230 to convert direct current as output by the battery 234 into alternating current as required by the corresponding electric motor 230. (Although the inverters 236 are shown schematically in FIG. 6 as proximate to the fore axle 234, FIG. 6 is not intended to indicate mounting of the inverters 236 onto the fore axle 234. Rather, mounting of the inverters 236 should be in any appropriate manner and location known in the art.)

Similarly to the vehicle 10 of the first embodiment, the vehicle 210 of the second embodiment is preferably configured such that the battery 234 receives power from a renewable energy source comprising a regenerative braking system 240, with the electric motors 230 additionally functioning as generators.

In a preferred embodiment, the control system 222 at least in part controls shifting of the frame by controlling the motor/generators 230. The control system 222 preferably includes additional features and capabilities as described above with regard to the first embodiment, including a user interface 242 facilitating powered adjustment of the rear axle assembly 216 into a suitable position.

### Dual Motors Driving a Single Axle in a Triple Axle Configuration

A third preferred vehicle is illustrated schematically in in FIG. 7. It is initially noted that, with certain exceptions to be discussed in detail below, many of the elements of the vehicle 310 of the third embodiment are the same as or very similar to those described in detail above in relation to the vehicle 10 of the first embodiment and/or the vehicle 210 of the second embodiment. Therefore, for the sake of brevity and clarity, redundant descriptions and numbering will be generally avoided here. Unless otherwise specified, the detailed descriptions of the elements presented above with respect to the first and/or second embodiment should therefore be understood to apply at least generally to the third embodiment, as well.

Similarly to the vehicle 10 and the vehicle 210, the vehicle 310 of the third preferred embodiment preferably includes a tractor 312 and a trailer 314. The trailer 314 includes a platform 215 configured to support cargo having a cargo weight. The vehicle 10 includes multiple axle assemblies, including a rear axle assembly 316. Wheels (not shown) and tires 318 are preferably mounted to respective ones of the axle assemblies, including the rear axle assembly 316.

Similarly to the rear axle assemblies 26 and 216, the rear axle assembly 316 of the third embodiment is shiftable in a fore-aft direction. Such shifting of the rear axle assembly 316 is powered.

More particularly, the vehicle 310 in a broad sense preferably includes a powered weight distribution system 320 including the rear axle assembly 316 and a control system 322 configured to at least in part control shifting of the rear axle assembly 316.

In contrast to dual axles as defined by the rear axle assemblies 26 and 216, however, the rear axle assembly 316 includes three (3) laterally extending, parallel fore, intermediate, and aft axles 324, 326, and 328, respectively, connected relative to a frame (not shown).

As described above with respect to the first and second embodiments of the present invention, the frame is preferably slidably mounted relative to the platform 315.

In the illustrated embodiment, the fore and rear axles 324 and 328 are non-drivable (i.e., rolling) axles. Most preferably, the fore and rear axles 324 and 328 are also lift axles.

In contrast, the intermediate axle 326 is a drivable axle 326. The drivable axle 326 preferably includes a pair of substantially aligned (i.e., along a shared lateral axis), rotatably drivable axle shafts (or “half shafts”) 330. Similarly to the rear axle assembly 216 of the second embodiment, a respective powering element 332 is provided to selectively rotatably drive each of the axle shafts 330. That is, a first powering element 332 drives a first one of the axle shafts 330, while a second powering element 332 drives a second one of the axle shafts 330. Powered or driven rotation of the intermediate axle 326 by the powering elements 332 shifts the frame (not shown) and the intermediate axle 326 (or, more broadly, the rear axle assembly 316) relative to the platform 315 and, more broadly, the remainder of the vehicle 310 when the frame is in an unlocked configuration.

Most preferably, each powering element 332 is an electric motor 332. In greater detail still, the electric motors 332 in the illustrated embodiment are each preferably high speed motors driving only the wheel or wheels (not shown) mounted to a given half shaft 330 of the rear axle assembly 316. The electric motors 332 may be sleeved into the existing drivable axle 326 or mounted directly onto the wheel hub (not shown).

It is preferred that gears 334 are provided for each motor 332 (e.g., to reduce the rotational speed between the respective motor 332 and any wheel or wheels and, in turn, tire or tires 318 associated with the given axle shaft 330).

In a preferred embodiment, as illustrated, the electric motors 332 receive power from a shared energy storage system 336. The energy storage system 336 is preferably a battery 336.

An independent inverter 338 is preferably provided for each motor 332 to convert direct current as output by the battery 336 into alternating current as required by the corresponding electric motor 332. (Although the inverters 338 are shown schematically in FIG. 7 as proximate to the fore axle 324, FIG. 7 is not intended to indicate mounting of the inverters 338 onto the fore axle 324. Rather, mounting of the inverters 338 should be in any appropriate manner and location known in the art.)

Similarly to the vehicle 10 of the first embodiment, the vehicle 310 of the third embodiment is preferably configured such that the battery 336 receives power from a renewable energy source comprising a regenerative braking system 342, with the electric motors 332 additionally functioning as generators.

In a preferred embodiment, the control system 322 at least in part controls shifting of the frame by controlling the motor/generators 332. The control system 322 preferably includes additional features and capabilities as described above with regard to the first embodiment, including a user interface 344 facilitating powered adjustment of the rear axle assembly 316 into a suitable position.

### Vehicle Integration and Systems Interoperability

According to some aspects of the present invention, the motor/generator 82 associated with the rear axle assembly 26 of the vehicle 10 of the first preferred embodiment, the motor/generators 230 associated with the rear axle assembly 216 of the vehicle 210 of the second preferred embodiment, and the motor/generators 332 associated with the rear axle assembly 316 of the vehicle 310 of the third preferred embodiment may be provided solely for facilitating powered shifting (i.e., repositioning) of the respective rear axle assemblies 26, 216, and 316, as described above. However, it is permissible according to some aspects of the present invention for relevant components of the powered weight distribution systems 68, 220, and 320 (including components of the rear axle assemblies 26, 216, and 316) to be incorporated into additional vehicle systems, including but not limited to those described below.

For purposes of clarity, the descriptions below will be written with reference to the vehicle 10 of the first preferred embodiment of the present invention. However, as will be readily understood by those of ordinary skill in the art, the principles described below may be equally applicable to the vehicles 210 and 310 of the second and third preferred embodiments, as well.

### Refrigerated Unit

According to some aspects of the present invention, the vehicle 10 might be a refrigerated truck, also commonly referred to as a “reefer” truck. In a conventional reefer truck, the cargo-containing area of the trailer is at least in part cooled. A separate diesel engine might power a generator that in turn operates a thermal refrigeration unit or TRU. The thermal refrigeration unit outputs cooled air into the refrigerated areas of the trailer.

In contrast, in the vehicle 10 of the present invention, energy captured by the motor/generator 82 of the regenerative braking system 96 and thereafter stored in the battery 90 might be transmitted from the battery 90, through an additional inverter (not shown), and to a thermal refrigeration unit (not shown). That is, the battery 90 might be configured to supply energy to both the motor/generator 82 (for powered driving of the aft axle 60 as described above), and to a cooling aggregate or thermal refrigeration unit.

The control system 70 would, in such an embodiment, be modified to manage the output of the battery 90 in an appropriate manner. For instance, control of the motor/generator 82 might be fully or partially integrated with a braking control system.

As noted briefly above, alternative or additional charging capability for the battery 90 might also be provided. For instance, energy might be provided via a grid or plug-in as at a rest station, etc.; via solar panels; via driving of the vehicle in dynamo mode; and/or via the primary traction motor (e.g., an internal combustion engine) of the vehicle.

Furthermore, use of the battery 90 to operate the thermal refrigeration unit might be situation dependent. For instance, the thermal refrigeration unit might be operated in a first manner during “normal” driving of the vehicle, in which brake usage is at or above a minimum level, but operated in a second manner during idling and/or other circumstances (including but not limited to driving with low brake usage, as might occur on an uncrowded interstate highway). Such circumstances may also be broadly dependent on the charge level of the battery 90.

### Traction Assistance

According to another aspect of the present invention, the vehicle 10 might additionally or alternatively utilize the motor/generator 82 to provide traction assistance for propulsion of the vehicle 10 in a general sense.

For instance, in a vehicle 10 featuring an electric motor as the primary traction motor, such assistance might be by transfer of energy from the motor/generator 82 to the battery 90 and, when appropriate, to the primary traction motor. This capability might in turn lead to advantageous range extension, reductions in maintenance and wear, improved stabilization, etc.

Alternatively, such assistance might be via direct propulsive operation of the motor/generator 82 to drive the aft axle 60 (e.g, through driven rotation of the aft axle 60 when the frame 72 is in a locked configuration). Such an approach would be applicable both to embodiments in which the primary traction motor is an internal combustion engine and to embodiments in which the primary traction motor is an electric motor. In the case of an internal combustion engine, those of ordinary skill in the art will appreciate that propulsion of the aft axle 60 would lessen the weight necessary to be pulled by the primary traction motor, leading to decreased fuel consumption thereby. Of course, as will also be readily apparent to those of ordinary skill in the art, additional advantages associated with decreased work performed by the primary traction motor, whether in the form of an electric motor or an internal combustion engine, may also be realized.

It is also permissible according to some aspects of the present invention for power from the battery 90 to be the sole source of propulsive power for vehicle 10 in certain circumstances, including but not limited to sufficiently low travel speeds, whether such power is supplied to the motor/generator 82 to drive the axle 60 (in association with any type of primary traction motor), to an electric primary traction motor, or to both the drive axle 60 and an electric primary traction motor.

According to some aspects of the present invention, such traction assistance function might incorporate “look-ahead” information from a navigation system, such that auxiliary power is provided only in the most beneficial scenarios (e.g., a hill-climb). The control system 70 may be configured to facilitate such control.

### Other Auxiliary Functions

Still further, the vehicle 10 might additionally or alternatively utilize energy captured by the motor/generator 82 and thereafter stored in the battery 90 to operate internal or external vehicle lights (e.g., headlights, in-cab lighting, etc.) or a user comfort system such as a climate-control system (e.g., cab heating and/or air conditioning). The battery 90 might also or alternatively supply power to a take-off system to facilitate improved initial acceleration of the vehicle 10, a stop system to facilitate improved braking of the vehicle 10 (e.g, via an anti-lock braking system), and/or a stability system for improving vehicle stability (e.g., via reduced slippage and/or skidding).

Other systems not listed herein but associated with vehicles and known to those of ordinary skill in the art to require power might also be integrated in some manner with the powered weight distribution system 68.

### CONCLUSION

The preferred forms of the invention described above are to be used as illustration only and should not be utilized in a limiting sense in interpreting the scope of the present invention. Obvious modifications to the exemplary embodiments, as hereinabove set forth, could be readily made by those skilled in the art without departing from the spirit of the present invention.

Although the above description presents features of preferred embodiments of the present invention, other preferred embodiments may also be created in keeping with the principles of the invention. Furthermore, as noted previously, these other preferred embodiments may in some instances be realized through a combination of features compatible for use together despite having been presented independently as part of separate embodiments in the above description.

The inventors hereby state their intent to rely on the Doctrine of Equivalents to determine and access the reasonably fair scope of the present invention as pertains to any apparatus not materially departing from but outside the literal scope of the invention set forth in the following claims.

What is claimed is:

1. A powered weight distribution system for a vehicle having a platform on which a load is supported, said powered weight distribution system comprising:
a shiftable axle assembly including—
a drivable axle,
a frame supporting the drivable axle,
said frame configured to be supported on the platform,
said frame being switchable between a locked configuration in which the frame is fixed relative to the platform and an unlocked configuration in which the frame is shiftable relative to the platform, and
a powering element configured to rotatably drive the drivable axle, such that the frame and the drivable axle shift relative to the platform when the frame is in the unlocked configuration and the drivable axle is rotated by the powering element.

2. The powered weight distribution system of claim 1,
said powering element comprising an electric motor.

3. The powered weight distribution system of claim 1,
said powering element receiving energy from a renewable energy source.

4. The powered weight distribution system of claim 3,
said powering element comprising a motor/generator.

5. The powered weight distribution system of claim 4,
said shiftable axle assembly further including an energy storage system configured to transfer energy to and receive energy from the motor/generator.

6. The powered weight distribution system of claim 5,
said shiftable axle assembly further including an inverter configured to convert direct current from the energy storage system to alternating current to power the motor/generator.

7. The powered weight distribution system of claim 5,
said shiftable axle assembly including a regenerative braking system,
said regenerative braking system including the motor/generator and the energy storage system.

8. The powered weight distribution system of claim 1, further comprising:
a control system configured to at least in part control shifting of the frame by controlling the powering element.

9. The powered weight distribution system of claim 8,
said control system configured to electronically control switching of the frame between said locked and unlocked configurations.

10. The powered weight distribution system of claim 8,
said control system configured to determine an acceptable position of the drive axle such that a weight at least in part supported by the drive axle is less than or equal to a predetermined allowed weight.

11. The powered weight distribution system of claim 10,
said control system including a load sensor configured to sense said weight.

12. The powered weight distribution system of claim 10,
said control system including a user interface indicating the acceptable position,
said user interface enabling a user to direct the control system to initiate and control shifting of the drivable axle to the acceptable position or to another position selected by the user.

13. The powered weight distribution system of claim 1,
said frame and said drivable axle being shiftable in a fore-aft direction,
said shiftable axle assembly further including a second axle disposed in line with and fore or aft of the drivable axle,
said frame additionally supporting the second axle, such that driven rotation of the drivable axle by the powering element when the frame is in the unlocked configuration results in shifting of the frame and both the drivable axle and the second axle relative to the platform.

14. The powered weight distribution system of claim 13,
said shiftable axle assembly further comprising a second powering element,
said second powering element configured to drive the second axle.

15. The powered weight distribution system of claim 13,
said shiftable axle assembly further including a third axle disposed in line with and fore or aft of the drivable axle, opposite the second axle, such that the drivable axle is disposed between said second and third axles,
said second and third axles being lift axles.

16. The powered weight distribution system of claim 1,
said powering element configured to provide power to an additional vehicle system or component.

17. The powered weight distribution system of claim 16,
said vehicle system or component being selected from the group consisting of a refrigeration unit, a primary vehicle propulsion motor, a light, a user comfort system, a take-off system, a stop system, a stability system, and combinations thereof

18. The powered weight distribution system of claim 1,
said drivable axle including a pair of at least substantially axially aligned drivable axle shafts,
said powering element configured to rotatably drive a first one of said drivable axle shafts,
said shiftable axle assembly further including a second powering element configured to rotatably drive a second one of said drivable axle shafts.

19. The powered weight distribution system of claim 1,
said drivable axle including a pair of drivable axle shafts,
said shiftable axle assembly further including a differential configured to transmit rotational energy from the powering element to each of said drivable axle shafts.

20. The powered weight distribution system of claim 1,
said shiftable axle assembly further including a mounting bracket configured to be fixed to the platform,
said frame being supported on the mounting bracket and shiftable relative thereto when in the unlocked configuration.
